(19) United States
(12) Patent Application Publication
(10) Pub. No.: US 2017/0064165 A1
(43) Pub. Date: Mar. 2, 2017

(54) VEHICLE-MOUNTED CAMERA AND METHOD OF MANUFACTURING VEHICLE-MOUNTED CAMERA

(71) Applicant: NIDEC ELESYS CORPORATION, Kawasaki-shi (JP)

(72) Inventor: Motoyasu ONISHI, Kawasaki-shi (JP)

(21) Appl. No.: 15/248,156

(22) Filed: Aug. 26, 2016

(30) Foreign Application Priority Data
Aug. 27, 2015 (JP) 2015-168103
Dec. 22, 2015 (JP) 2015-249841
Jul. 28, 2016 (JP) 2016-148810

(51) Int. Cl. H04N 5/225; B60R 11/04

(52) U.S. Cl. CPC H04N 5/2253; H04N 5/2252; B60R 11/04; B60R 2011/0026

(57) ABSTRACT

A vehicle-mounted camera is attached to a glass surface of a window glass inside a vehicle in a posture in which the vehicle-mounted camera extends along the window glass of a vehicle body, and captures an image of a scene of a vehicle exterior. The vehicle-mounted camera includes a cover housing and a camera main assembly fixed to the cover housing and including a lens assembly and an image sensor. A bearing mechanism is interposed between the camera main assembly and the cover housing. A rotation axis of the bearing mechanism extends in the left-right direction defined relative to a front-back direction in which an optical axis of the lens assembly extends. The vehicle-mounted camera includes a fixing member that fixes the bearing mechanism and contacts both of the camera main assembly and the cover housing or the bearing mechanism.

### BACKGROUND OF THE INVENTION

1. Field of the Invention

The present invention relates to a vehicle-mounted camera and a method of manufacturing a vehicle-mounted camera.

2. Description of the Related Art

There has been used a vehicle-mounted camera that performs image processing of an image captured by a camera attached to a vehicle to extract information regarding a traffic lane, a preceding vehicle, an oncoming vehicle, a person, or a traffic sign from the image. The vehicle-mounted camera is applied to a vehicle-mounted system that supports safe traveling of the vehicle.

In recent years, a variety of sensors such as rain sensor, an illuminance sensor, and a millimeter wave or laser radar sensor have been mounted on vehicles. Therefore, an attachment space for the vehicle-mounted camera is required to be reduced. Further, the vehicle-mounted camera needs to be prevented from hindering driving of a driver, for example, blocking the visual field of the driver or giving an oppressive feeling to the driver. The vehicle-mounted camera is therefore attached along the front window of the vehicle.

When the vehicle-mounted camera is attached to the vehicle, angle adjustment (optical axis adjustment) needs to be performed (see Japanese Patent Application Laid-Open No. 2010-89745). Japanese Patent Application Laid-Open No. 2010-89745 describes an optical-axis adjusting system including driving means for driving a posture of the vehicle-mounted camera according to operation from the outside and retaining means for retaining the driving means in a predetermined position.

However, since the vehicle-mounted camera described in Japanese Patent Application Laid-Open No. 2010-89745 includes angle adjusting mechanisms such as the driving means and the retaining means, the number of components increases and the structure of the vehicle-mounted camera is complicated. As a result, an increase in costs of the vehicle-mounted camera is caused. Moreover, the vehicle-mounted camera is increased in size.

### SUMMARY OF THE INVENTION

Preferred embodiments of the present invention provide vehicle-mounted cameras that allow for easy angle adjustment of an optical axis as well as cost reduction and downsizing, and methods of manufacturing the vehicle-mounted cameras.

A vehicle-mounted camera according to a preferred embodiment of the present invention is a vehicle-mounted camera attached to a glass surface of a window glass inside a vehicle in a posture in which the vehicle-mounted camera extends along the window glass facing forward or rearward of a vehicle body, and being configured to capture an image of a scene of a vehicle exterior. The vehicle-mounted camera includes a cover housing; and a camera main assembly fixed to the cover housing and including a lens assembly and an image sensor. A bearing mechanism is interposed between the camera main assembly and the cover housing. When a direction in which an optical axis of the lens assembly extends is defined as the front-back direction, a rotation axis of the bearing mechanism extends in the left-right direction. The vehicle-mounted camera includes a fixing member that fixes the bearing mechanism to be incapable of rotating. The fixing member is configured to come into contact with both of the camera main assembly and the cover housing or the bearing mechanism.

With preferred embodiments of the present invention, it is possible to provide a vehicle-mounted camera that allows for easy angle adjustment of an optical axis as well as cost reduction and downsizing.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a sectional schematic view of a vehicle body according to a preferred embodiment of the present invention.

FIG. 2 is an exploded perspective view of a vehicle-mounted camera according to a preferred embodiment of the present invention.

FIG. 3 is an exploded side view of a vehicle-mounted camera according to a preferred embodiment of the present invention.

FIG. 4 is an exploded perspective view of a vehicle-mounted camera according to a preferred embodiment of the present invention.

FIG. 5 is a perspective view of a bearing mechanism according to a preferred embodiment of the present invention.

FIG. 6 is a perspective view of a vehicle-mounted camera and an attachment member according to a preferred embodiment of the present invention.

FIG. 7 is a side view of a vehicle-mounted camera according to a preferred embodiment of the present invention and shows a state in which the vehicle-mounted camera is attached to a front window.

FIG. 8 is a sectional view of a vehicle-mounted camera according to a preferred embodiment of the present invention and shows a state in which the vehicle-mounted camera is attached to the front window.

FIG. 9 is a sectional view of a vehicle-mounted camera according to a preferred embodiment of the present invention and shows a state in which the vehicle-mounted camera is attached to the front window.

FIG. 10 is an exploded perspective view of a vehicle-mounted camera according to Variation 1 of a preferred embodiment of the present invention.

FIG. 11 is a perspective view of a bearing mechanism according to Variation 1 of a preferred embodiment of the present invention.

FIG. 12 is a partial schematic view of a vehicle-mounted camera according to Variation 2 of a preferred embodiment of the present invention.

FIG. 13 is a partial schematic view of a vehicle-mounted camera according to Variation 3 of a preferred embodiment of the present invention.

FIG. 14 is a partial schematic view of a vehicle-mounted camera according to Variation 4 of a preferred embodiment of the present invention.

FIG. 15 is a partial schematic view of a vehicle-mounted camera according to Variation 5 of a preferred embodiment of the present invention.

### DETAILED DESCRIPTION OF THE PREFERRED EMBODIMENTS

A vehicle-mounted camera 100 according to a preferred embodiment will be described with reference to the drawings.

In the following explanation of the vehicle-mounted camera 100, the vehicle width direction of a vehicle body 1 at the time when the vehicle-mounted camera 100 is attached to the vehicle body 1 is defined as the width direction or left-right direction of the vehicle-mounted camera 100, the front-back direction of the vehicle body 1 is defined as the front-back direction of the vehicle-mounted camera 100, and the vertical direction of the vehicle body 1 is defined as the vertical direction of the vehicle-mounted camera 100. Note that the postures and the layout of members of the vehicle-mounted camera 100 are illustrative only and can be modified without departing from the spirit of the present invention.

FIG. 1 is a sectional schematic view of the vehicle body 1 mounted with the vehicle-mounted camera 100. The vehicle body 1 includes a window glass 50 facing forward (hereinafter, front window) and a window glass 55 facing rearward (hereinafter, rear window). The vehicle-mounted camera 100 is attached to a glass surface 51 on a vehicle interior 9 side of the front window 50 via an attachment member 60 in a posture in which the vehicle-mounted camera 100 extends along the front window 50 and used to capture an image of a scene ahead of a vehicle exterior 8.

Note that, as indicated by an alternate long and two short dashes line in FIG. 1, the vehicle-mounted camera 100 may be attached to a glass surface 56 on the vehicle interior 9 side of the rear window 55 via the attachment member 60 in a posture in which the vehicle-mounted camera 100 extends along the rear window 55. When the vehicle-mounted camera 100 is attached to the rear window 55, the vehicle-mounted camera 100 is used to capture an image of a scene of the vehicle exterior 8 behind the vehicle body 1.

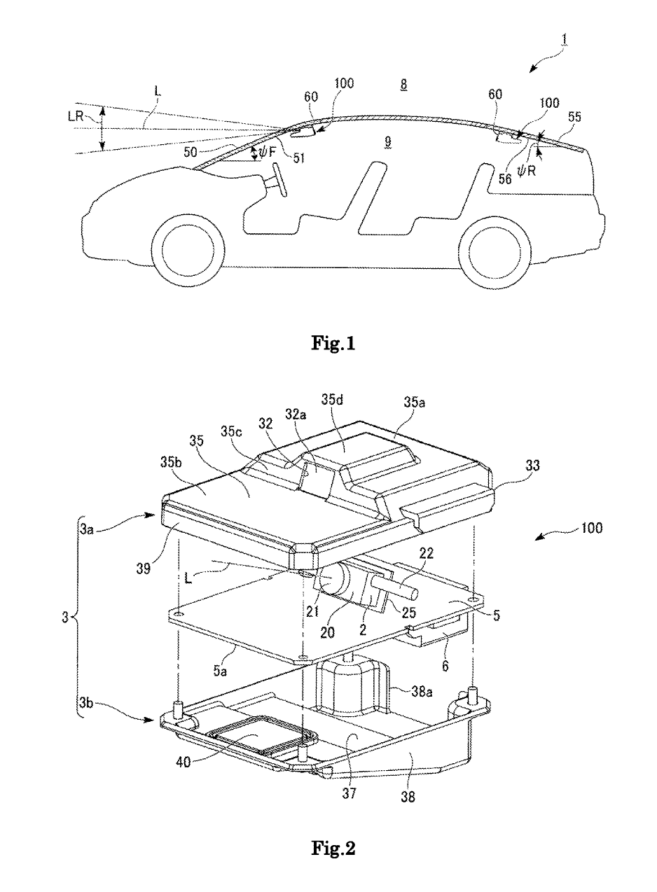

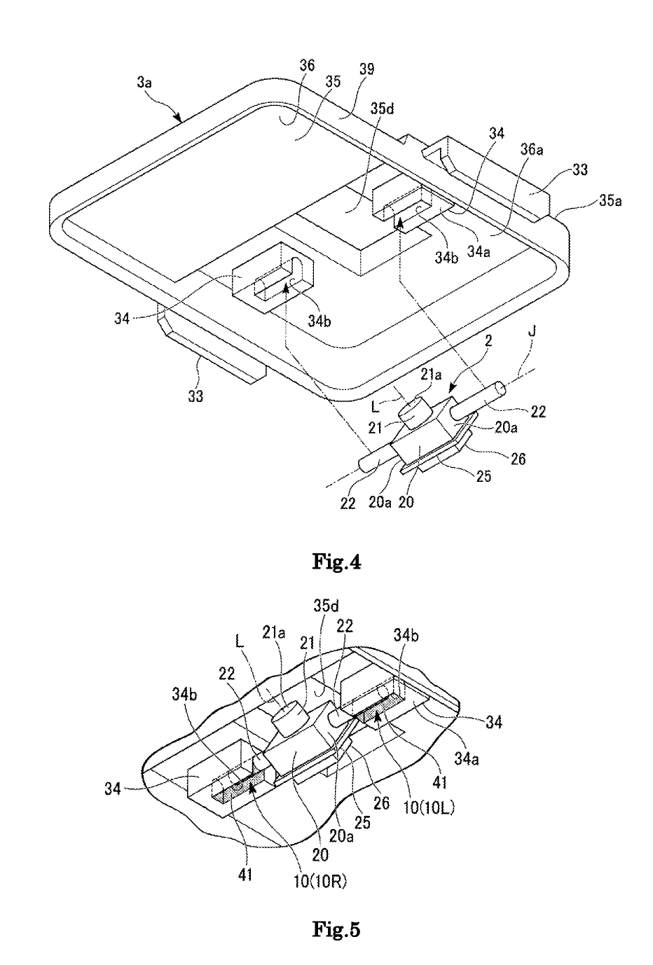

FIGS. 2 to 4 are exploded views of the vehicle-mounted camera 100. FIG. 5 is a partially enlarged perspective view of the vehicle-mounted camera. Note that, in FIG. 4, illustration of a processing board 5 and a base housing 3b is omitted.

As shown in FIGS. 2, 3 and 5, the vehicle-mounted camera 100 includes a housing 3, a camera main assembly 2, and a processing board 5. The vehicle-mounted camera 100 includes an adhesive (a fixing member) 41 that fixes the housing 3 and the camera main assembly 2. The housing 3 includes a cover housing 3a and a base housing 3b.

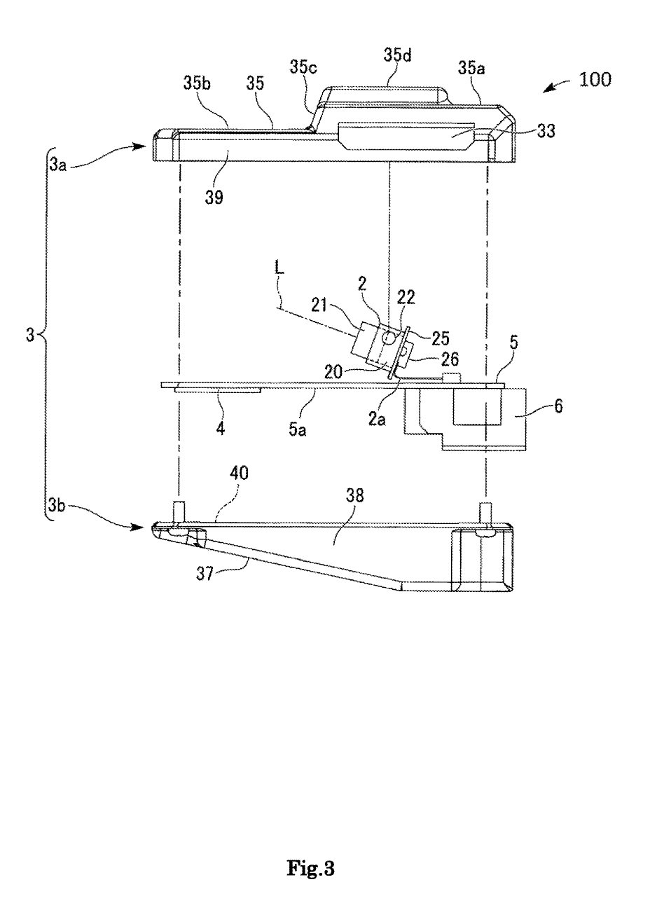

The processing board 5 stores an image and a video captured by the camera main assembly 2 or transmits the image and the video to other apparatuses. As shown in FIG. 3, a processing circuit element 4, a connector 6, and a power supply circuit element, a capacitor, a microcomputer, an IC, and the like e, all of which are not illustrated in the drawings, are mounted on the processing board 5. The processing board 5 is connected to the camera main assembly 2 via a wire 2a. Examples of modes and wiring of the power supply circuit element, the capacitor, the microcomputer, and the IC are described in U.S. Patent Application Publication No. 2016/0091602, filed Sep. 23, 2015; U.S. Patent Application Publication No. 2015/0042798, filed Aug. 8, 2013; and U.S. Patent Application Publication No. 2015/0042874, filed May 5, 2014, which are hereby all incorporated herein by reference in their entireties.

The processing circuit element 4 electronically processes an image captured by an image sensor 26 of the camera main assembly 2. The processing circuit element 4 is provided in a front part of a lower surface 5a of the processing board 5. The processing circuit element 4 performs processing for extracting various characteristic objects such as a vehicle, a pedestrian, and a traffic lane concerning visual information focused on the image sensor. The processing circuit element 4 is in contact with the base housing 3b via a heat radiation member 40. Examples of the heat radiation member 40 include a heat radiation plate (sheet) and a heat radiation gel. As the material of the heat radiation plate (sheet) and the heat radiation gel, a silicon-based material or the like is used. The processing circuit element 4 generates heat when the vehicle-mounted camera 100 is driven. Since the processing circuit element 4 is in contact with the base housing 3b via the heat radiation member 40, heat radiation performance of the vehicle-mounted camera 100 is improved.

A wire extending to a not-shown external apparatus is connected to the connector 6 (a power supply connector). The connector 6 is provided in a rear part of the lower surface 5a of the processing board 5. The connector 6 relays power supply and communication to the vehicle-mounted camera 100.

In a preferred embodiment of the present invention, another processing board can also be used instead of the processing board 5. The examples of the processing board are described in U.S. Patent Application Publication No. 2015/0042798, filed Aug. 8, 2013; U.S. Patent Application Publication No. 2015/0042874, filed May 5, 2014; and Japanese Patent Application No. 2015-254737, filed December 25, which are hereby all incorporated herein by reference in their entireties.

The housing 3 houses the processing board 5 and mounted components on the processing board 5 and the camera main assembly 2.

The housing 3 includes the cover housing 3a that supports the camera main assembly 2 and the base housing 3b attached on the lower side of the cover housing 3a for supporting the processing board 5. Note that the housing 3 may not include the base housing 3b. If the housing 3 does not include the base housing 3b, the processing board 5 is fixed to the lower surface of the cover housing 3a.

As shown in FIG. 2, the cover housing 3a includes a tabular top plate 35, and a peripheral edge portion 39 extending to the lower side from the peripheral edge of the top plate 35. The cover housing 3a is fixed to the base housing 3b by screws in the peripheral edge portion 39. Note that the cover housing 3a may not include the peripheral edge portion 39 as long as the cover housing 3a includes the top plate 35.

The top plate 35 includes a top plate front portion 35b, a top plate rear portion 35a, and a riser 35c. The top plate front portion 35b is located in a front region in the top plate 35. The top plate rear portion 35a is located in a rear region of the top plate front portion 35b. The top plate rear portion 35a is located above the top plate front portion 35b. The riser 35c is disposed in the boundary between the top plate rear portion 35a and the top plate front portion 35b.

A camera housing portion 35d is provided in the width direction center of the top plate rear portion 35a. The camera housing portion 35d has a shape projecting above the top plate rear portion 35a. The camera main assembly 2 is accommodated in a space below the camera housing portion 35d.

In the riser 35c, a viewing window 32 is provided in a portion located in the front of the camera housing portion 35d. The viewing window 32 is an opening through which an optical axis L of the camera main assembly 2 passes. The camera main assembly 2 captures an image on the outside of the vehicle through the viewing window 32. The viewing window 32 is closed by a transparent plate 32a that prevents ingress of dust into the inner side of the housing 3.

As shown in FIG. 4, a pair of housing-side seats 34 projecting downward is provided in a lower-surface rear portion 36a located on the lower side of the top plate rear portion 35a on a lower surface 36 of the top plate 35. The pair of housing-side seats 34 is respectively located on the left and the right of the camera housing portion 35d.

The housing-side seats 34 have a square pole shape. Bearing portions 34b are provided on lower surfaces 34a of the housing-side seats 34. In this preferred embodiment, the bearing portions 34b are recessed grooves extending in the width direction. In this variation, the bottom surfaces of the bearing portions 34b are semicircular curved surfaces having a uniform shape along the width direction. Note that the cross section of the bearing portions 34b may be rectangular. In the bearing portions 34b, shaft portions 22 of the camera main assembly 2 described below are accommodated.

The projections for attachment 33 are respectively provided on width direction both sides of the peripheral edge portion 39 of the cover housing 3a. The projections for attachment 33 are used for attachment of the vehicle-mounted camera 100 to the vehicle body 1 described below.

The base housing 3b covers the processing board 5 from the lower side. The height of the base housing 3b gradually decreases from the back to the front. The base housing 3b includes a sidewall portion 38 and a bottom portion 37. The heat radiation member 40 is provided in a front part of the bottom portion 37 in a position brought into contact with the processing circuit element 4. The sidewall portion 38 extends upward from the peripheral edge of the bottom portion 37. An opening 38a is provided in a rear part of the sidewall portion 38. Since the opening 38a is provided, the connector 6 mounted on the processing board 5 is exposed from the rear side of the sidewall portion 38. It is possible to connect a wire (not shown in the figure) extending to the external apparatus.

In this preferred embodiment, the cover housing 3a and the base housing 3b are made of aluminum or an aluminum alloy and are molded by pressing or a die cast forging method. Since the cover housing 3a and the base housing 3b are made of aluminum or an aluminum alloy, it is possible to increase a heat capacity of the entire housing 3 and transfer heat generated from the processing board 5 to effectively cool the processing board 5.

As shown in FIG. 4, the camera main assembly 2 is fixed to the cover housing 3a in a housing-side seat 34. Since the cover housing 3a is made of aluminum or an aluminum alloy, it is possible to suppress deformation under an external force and secure attachment accuracy of the camera main assembly 2.

The camera main assembly 2 is a device for capturing an image of a scene ahead of the vehicle body 1 as visual information.

As shown in FIG. 3, the camera main assembly 2 has one optical axis L. The camera main assembly 2 includes a base unit 20, a lens assembly 21, an image sensor board 25, and the image sensor 26. The camera main assembly 2 is fixed to the cover housing 3a.

The lens assembly 21 includes a plurality of lenses, the optical axes of which are aligned, and a barrel having a cylindrical shape that holds the lenses. A common optical axis of the plurality of lenses is the optical axis L of the camera main assembly 2. The lens assembly 21 projects to the front of the base unit 20 and is fixed to the base unit 20. The image sensor 26 is disposed behind the lens assembly 21.

The image sensor board 25 is fixed to the rear surface of the base unit 20. The image sensor 26 is mounted on the image sensor board 25.

The image sensor 26 acquires visual information in an outside world as an image. The image sensor 26 captures an object image focused through the lens assembly 21. As the image sensor 26, for example, a CMOS image sensor is used.

The base unit 20 is pierced through by the lens assembly 21. The base unit 20 holds the outer circumference of the lens assembly 21. As shown in FIG. 4, a pair of shaft portions 22 extending toward the width-direction outer side is provided on outer side surfaces 20a on the width-direction both sides of the base unit 20. The shaft portions 22 extend in directions away from each other from the optical axis L. The pair of shaft portions 22 has a columnar shape centering on a center axis (a rotation axis) J common to the shaft portions 22. The center axis J of the shaft portions 22 is located between a distal end 21a of the lens assembly 21 and the image sensor 26 in the front-back direction.

FIG. 5 is a partially perspective view of the vehicle-mounted camera. As shown in FIG. 5, the shaft portions 22 are accommodated in the bearing portions 34b of the cover housing 3a and configure a bearing mechanism 10. That is, the bearing mechanism 10 including the shaft portions 22 of the camera main assembly 2 and the bearing portions 34b of the cover housing 3a is interposed between the camera main assembly 2 and the cover housing 3a. The diameter of the shaft portions 22 is the same as or slightly smaller than the width dimension of the bearing portions 34b having a recessed groove shape. The bottom surfaces of the bearing portions 34b are curved along the outer circumferential surfaces of the shaft portions 22. The shaft portions 22 are capable of rotating about the center axis J with respect to the bearing portions 34b. Therefore, the bearing mechanism 10 can rotate the camera main assembly 2 with respect to the cover housing 3a. The vehicle-mounted camera 100 captures an image of a scene ahead of (or behind) the vehicle body 1. Therefore, a direction in which the optical axis L extends is the front-back direction. On the other hand, the center axis J of the shaft portions 22, which is the rotation axis of the bearing mechanism 10, extends in the left-right direction, which is the width direction of the vehicle-mounted camera 100. Therefore, by rotating the camera main assembly 2 with the bearing mechanism 10, it is possible to vertically change the direction of the optical axis L of the camera main assembly 2 and adjust an angle of elevation (or an angle of depression) of the optical axis L.

The center axis (the rotation axis) J is preferably disposed close to the viewing window 32 such that the optical axis L does not deviate from the viewing window 32 of the cover housing 3a when the bearing mechanism 10 is rotated. As described above, the center axis J is located between the distal end 21a of the lens assembly 21 and the image sensor 26 in the front-back direction. Consequently, in the camera main assembly 2, it is possible to dispose the center axis J close to the viewing window 32. Even if the direction of the optical axis L is adjusted, the optical axis L less easily deviates from the viewing window 32.

In the vehicle-mounted camera 100 In this preferred embodiment, the bearing mechanism 10 includes a left bearing mechanism 10L and a right bearing mechanism 10R extending in directions away from the optical axis L and located on the left and the right of the optical axis L. Since the bearing mechanism 10 includes the left bearing mechanism 10L and the right bearing mechanism 10R, the bearing mechanism 10 can stably support the camera main assembly 2 from the left and the right.

The bearing mechanism 10 is fixed to be incapable of rotating by the adhesive (the fixing member) 41. In a state in which the shaft portions 22 are accommodated in the bearing portions 34b, the adhesive 41 is filled in the bearing portions 34b in an unhardened state and hardened. The adhesive 41 is hardened in a state in which the camera main assembly 2 is rotated by the bearing mechanism 10 to align the optical axis L in a desired direction. As the adhesive 41, for example, an ultraviolet curing adhesive is preferably used.

In this preferred embodiment, the adhesive 41 is in contact with the bearing mechanism 10 (the shaft portions 22 and the bearing portions 34b). However, the adhesive 41 is not limited to this configuration as long as the adhesive 41 suppresses the rotation of the bearing mechanism 10. For example, the adhesive 41 may be in contact with both of the camera main assembly 2 and the cover housing 3a without being in contact with the bearing mechanism 10 to fix a relative positional relation of the camera main assembly 2 and the cover housing 3a.

Attachment of the vehicle-mounted camera 100 to the vehicle body 1 will be described.

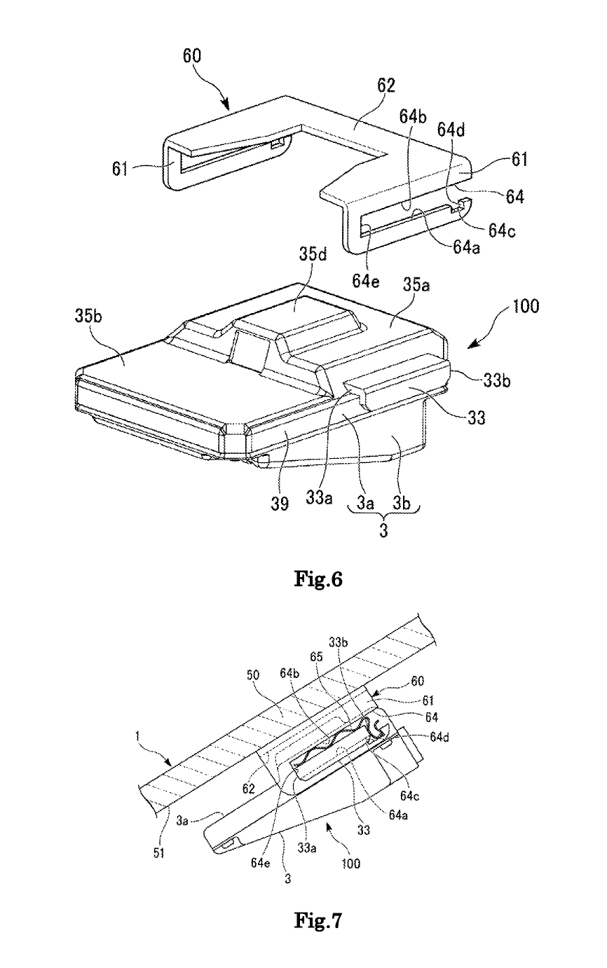

FIG. 6 is a perspective view of the vehicle-mounted camera 100 and the attachment member 60 used for the attachment of the vehicle-mounted camera 100 to the vehicle body 1. FIG. 7 is a side view showing a state in which the vehicle-mounted camera 100 is attached to the vehicle body 1.

As shown in FIG. 6, the attachment member 60 includes a glass surface fixing portion 62 having a flat shape and a pair of supporting portions 61 extending downward from width direction both end portions of the glass surface fixing portion 62.

The glass surface fixing portion 62 of the attachment member 60 covers the top plate rear portion 35a excluding the camera housing portion 35d in the top plate 35 of the cover housing 3a. As shown in FIG. 7, the attachment member 60 is fixed to the glass surface 51 of the front window 50 on the upper surface of the glass surface fixing portion 62. The glass surface fixing portion 62 and the glass surface 51 are fixed by, for example, a double sided tape or an adhesive. The attachment member 60 is fixed to a predetermined position of the front window 50, for example, the glass surface 51 near a rear view mirror.

A slit for attachment 64 is provided in a supporting portion 61 of the attachment member 60. The slit for attachment 64 has a cutout shape opened to the rear side of the supporting portion 61. The slit for attachment 64 includes a lower side surface 64a and an upper side surface 64b vertically opposed to each other. On the lower side surface 64a, a concave 64c recessed toward the lower side is provided on the rear side. As shown in FIG. 7, a projection for attachment 33 of the cover housing 3a is inserted into the slit for attachment 64 from the back to the front. Consequently, the projection for attachment 33 is mounted on the lower side surface 64a. A wavy leaf spring 65 is held between the upper side surface 64b and the projection for attachment 33 in the vertical direction. The leaf spring 65 presses the projection for attachment 33 against the lower side surface 64a to stabilize the contact of the projection for attachment 33 and the lower side surface 64a. The leaf spring 65 extends to the rear side and is disposed between a rear end face 33b of the projection for attachment 33 and a surface 64d facing the front of the concave 64c. The leaf spring 65 presses the projection for attachment 33 forward and brings the front end face 33a of the projection for attachment 33 into contact with a surface 64e facing rearward of the slit for attachment 64. Consequently, the leaf spring 65 suppresses the vehicle-mounted camera 100 from moving in the front-back direction with respect to the attachment member 60.

As described above, the attachment member 60 and the leaf spring 65 support the vehicle-mounted camera 100 in a state in which the attachment member 60 and the leaf spring 65 maintain a fixed relative positional relation with respect to the vehicle body 1. The vehicle-mounted camera 100 is attached to the attachment member 60 fixed to the glass surface 51. Therefore, the top plate 35 of the cover housing 3a takes a posture in which the top plate extends along the front window 50 of the vehicle body 1. Since the vehicle-mounted camera 100 is attached along the glass surface 51, the vehicle-mounted camera 100 does not block the forward visual field of a driver.

Next, non-limiting examples of a method of manufacturing and attaching a vehicle-mounted camera adapted to various car models will be described.

As shown in FIG. 1, the glass surface 51 of the front window 50 of the vehicle body 1 tilts at an inclination angle ψF. Each car model of the vehicle body 1 has a different inclination angle ψF. A method of manufacturing the vehicle-mounted camera 100 to the vehicle body 1 having various inclination angles W with the optical axis L of the camera main assembly 2 set to a preferred angle is described.

Note that, when the vehicle-mounted camera 100 is attached to the glass surface 56 of the rear window 55, according to a method same as the method described above, the optical axis L of the camera main assembly 2 is set to a preferred angle with respect to an inclination angle ψR of the glass surface 56 that is different for each of the car models.

In general, the front window 50 curves from the center toward the width direction. In this preferred embodiment, the curve of the front window 50 is neglected assuming that the vehicle-mounted camera 100 is attached to the width direction center of the front window 50. Note that, when the vehicle-mounted camera 100 is attached to a position deviating to a width direction one side of the front window 50, the optical axis L tilts in the left-right direction. In this case, the tilt in the left-right direction can be corrected by image processing in the processing circuit element 4.

As shown in FIG. 1, the vehicle-mounted camera 100 is attached to the vehicle body 1 such that the optical axis L fit within an tolerable direction range LR having a predetermined angle width. When the optical axis L is outside the tolerable direction range LR, the vehicle-mounted camera 100 cannot sufficiently secure the visual field of the camera main assembly 2 and cannot sufficiently obtain information necessary for vehicle body control. The tolerable direction range LR is set in advance on the basis of the horizontal direction.

Unless specifically described otherwise in the following explanation, as the direction of the optical axis L, the horizontal direction included in the tolerable direction range LR is selected.

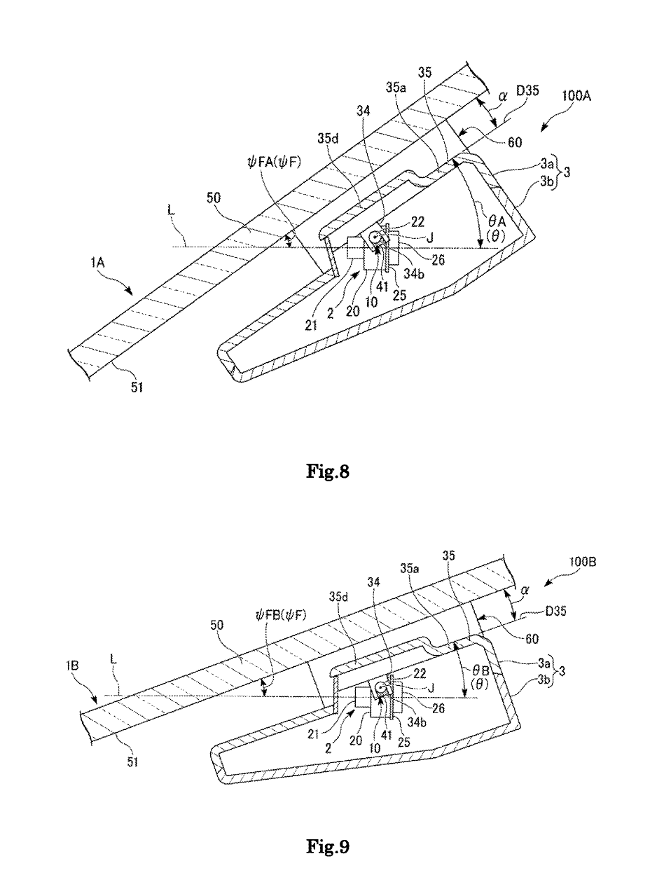

FIGS. 8 and 9 are respectively sectional views of vehicle-mounted cameras 100A and 100B attached to vehicle bodies 1A and 1B including the front windows 50 respectively inclining at inclination angles ψFA and ψFB. In the vehicle body 1A and the vehicle body 1B, the inclination angles ψFA and ψFB of the front windows 50 have a relation ψFA>ψFB. Note that FIGS. 8 and 9 are sectional views schematically showing the camera main assembly 2 and the cover housing 3a to clearly show a fixing relation thereof. The members are illustrated differently from the members in actual sectional views.

An inclination angle of the optical axis L with respect to the top plate 35 of the cover housing 3a is represented as an attachment angle θ (θA, θB). The direction of the optical axis L adjusted by rotating the bearing mechanism 10 is described.

In the following explanation, the vehicle bodies 1A and 1B are described as the vehicle body 1 in common, the vehicle-mounted cameras 100A and 100B are described as the vehicle-mounted camera 100 in common, and the attachment angles θA and θB are described as the attachment angle θ in common.

In this preferred embodiment, the optical axis L is set in the horizontal direction. Therefore, the inclination angle ψF, which is an angle of depression of the glass surface 51 with respect to the horizontal surface, is equal to an angle formed by the glass surface 51 and the optical axis L.

When assembly of the vehicle-mounted camera 100 is performed, the inclination angle ψF of the glass surface 51 of the front window 50 of the vehicle body 1, to which the vehicle-mounted camera 100 is attached, is specified. The inclination angle ψF can be specified by measuring the inclination angle ψF of the attachment target vehicle body 1. As the inclination angle ψF, the inclination angle ψF of the target vehicle body 1 may be specified from a database of inclination angles for each of car models.

Subsequently, the direction of the optical axis L of the camera main assembly 2 including the bearing mechanism 10 is determined according to the specified inclination angle ψF of the glass surface 51. That is, the attachment angle θ of the camera main assembly 2 to the cover housing 3a is specified on the basis of the inclination angle ψF.

The direction of the upper surface of the top plate 35 (more specifically, the upper surface of the top plate rear portion 35a) is represented as a top plate direction D35. In this specification, the direction means a tilting direction within a plane including the front-back direction and the perpendicular direction (the vertical direction). Similarly, the inclination angle ψF, the attachment angle θ, and a difference α described below are angles formed by the directions within the plane including the front-back direction and the perpendicular direction (the vertical direction).

As shown in FIGS. 8 and 9, the top plate 35 of the cover housing 3a is disposed at an angle difference of the difference α with respect to the glass surface 51. That is, an angle difference between the direction of the glass surface 51 and the direction of the top plate 35 (the top plate direction D35) is represented by the difference α. The difference α is an angle determined by the posture of the cover housing 3a with respect to the glass surface 51. Therefore, the difference α remains unchanged no matter what type of vehicle the vehicle-mounted camera 100 is attached to, as long as the configurations of the cover housing 3a and the attachment member 60 are not changed. In this preferred embodiment, in both of the vehicle-mounted cameras 100A and 100B, the direction of the glass surface 51 and the top plate direction D35 are parallel and the difference α is 0°.

The attachment angle θ is an angle difference of the optical axis L of the camera main assembly 2 with respect to the top plate direction D35. A tilt component of the optical axis L of the camera main assembly 2 with respect to the glass surface 51 is represented by a sum of the difference α and the attachment angle θ. That is, the inclination angle ψF, the attachment angle θ, and a difference α have a relation of the following Expression 1.

ψF=α+θ Expression 1

Note that, in Expression 1, the difference α has positive and negative angles. The difference α is an angle of the top plate direction D35 with respect to the direction of the glass surface 51. In FIGS. 8 and 9, an angle in the right rotation direction is a positive angle. The difference α may be a negative angle.

Expression 1 can be transformed into the following Expression 2.

θ=ψF−α Expression 2

As indicated by Expression 2, the attachment angle θ can be determined by the inclination angle ψF and the difference α. The difference α is an angle depending on an attachment posture of the cover housing 3a to the glass surface 51 and is a constant In this preferred embodiment. The inclination angle ψF is specified by the vehicle body 1. Note that, in both examples shown in FIGS. 8 and 9, the difference α is 0°. In such a case, the attachment angle θ only has to be set the same as the inclination angle ψF of the glass surface 51.

The attachment angle θ can be set as appropriate by adjusting the angle of the camera main assembly 2 with respect to the cover housing 3a in the bearing mechanism 10. That is, the camera main assembly 2 is attached to the cover housing 3a with the direction of the optical axis L aligned to be attached at a preferred attachment angle θ calculated on the basis of Expression and is fixed by the adhesive (the fixing member) 41. More specifically, first, the shaft portion 22 of the camera main assembly 2 is inserted into the bearing portion 34b of the cover housing 3a to attach the camera main assembly 2 to the cover housing 3a. Subsequently, the attachment angle θ of the camera main assembly 2 is adjusted to a specified angle using the bearing mechanism 10 formed by the shaft portion 22 and the bearing portion 34b. Subsequently, the bearing mechanism 10 is fixed to be incapable of rotating by the adhesive (the fixing member) 41.

Subsequently, the processing board 5 and the base housing 3b are fixed to the cover housing 3a to which the camera main assembly 2 is fixed according to the procedure described above. Consequently, the assembly of the vehicle-mounted camera 100 is completed.

Subsequently, as shown in FIG. 7, the attachment member 60 is fixed to the glass surface 51 of the front glass 50. Further, the vehicle-mounted camera 100 including the cover housing 3a, to which the camera main assembly 2 is attached, is attached to the attachment member 60. Consequently, the vehicle-mounted camera 100 can be fixed to the glass surface 51 of the vehicle body 1 via the attachment member 60. The attachment member 60 may be fixed to the glass surface 51 after the vehicle-mounted camera 100 is attached to the attachment member 60. Consequently, it is possible to attach the vehicle-mounted camera 100 to the vehicle body 1 with the optical axis L set within the tolerable direction range LR (see FIG. 1).

Subsequently, direction adjustment processing of the camera main assembly 2 in the vehicle-mounted camera 100 is performed. The direction adjustment processing corresponds to a calibration of the vehicle-mounted camera 100 by electronic processing.

As shown in FIG. 1, the optical axis L of the vehicle-mounted camera 100 is set within the tolerable direction range LR. Therefore, the optical axis L of the vehicle-mounted camera 100 sometimes has deviation with respect to a most preferred optical axis direction within the tolerable direction range LR. In an assembly process of the vehicle-mounted camera 100, deviation sometimes occurs with respect to the optical axis L in terms of a design value because of an assembly error. The vehicle-mounted camera 100 In this preferred embodiment can calibrate, with electronic processing, the deviation with respect to the most preferred optical axis direction by performing the direction adjustment processing. In the direction adjustment processing, attachment direction detection processing and direction calculation processing described below are executed.

The processing circuit 4 mounted on the processing board 5 of the vehicle-mounted camera 100 is capable of executing at least attachment direction detection processing and direction calculation processing by electronically processing an image captured by the camera main assembly 2.

Attachment direction detection processing executed by the processing circuit 4 will be described.

In the attachment direction detection processing, first, in a state in which the vehicle-mounted camera 100 is attached to the glass surface 51 via the attachment member 60, the camera main assembly 2 captures an image of a target object for direction detection located in a known direction when viewed from the vehicle body 1. Consequently, the processing circuit 4 acquires a captured target object image of the target object for direction detection. Further, the processing circuit 4 detects the position of the target object for direction detection on the captured target object image. On the other hand, the processing circuit 4 causes, on the basis of the known direction, the driver to recognize an original position, which is a position where the target object for direction detection should be originally present on the image. The processing circuit element 4 calculates an attachment direction deviation using the original position and the position on the image and records the attachment direction deviation. That is, the processing circuit 4 calculates an attachment direction deviation of the camera main assembly 2 using the known direction and the position of the target object for direction detection and stores the attachment direction deviation.

Direction calculation processing executed by the processing circuit 4 will now be described.

In the direction calculation processing, the processing circuit 4 calculates, using the attachment direction deviation calculated by the attachment direction detection processing, from a position on an image of an object captured by the camera main assembly 2, an original direction in which the object is located when viewed from the vehicle body 1. In the direction calculation processing, the processing circuit 4 may calculate an original direction on the basis of the known direction and the position of the target object for direction detection acquired during the calculation of the attachment direction deviation described above. The processing circuit 4 can reduce a direction error of the vehicle-mounted camera by executing the direction calculation processing.

Note that the attachment direction detection processing and the direction calculation processing performed by the electronic processing in the processing circuit 4 of the vehicle-mounted camera 100 are described above. Besides, the attachment direction detection processing and the direction calculation processing may be performed according to an image processing program of an external apparatus connected to the vehicle-mounted camera 100.

As described above, according to this preferred embodiment, it is possible to provide a vehicle-mounted camera and the method of manufacturing the vehicle-mounted camera that is low in costs and easy in angle adjustment of the optical axis L.

A vehicle-mounted camera 200 according to Variation 1 will now be described.

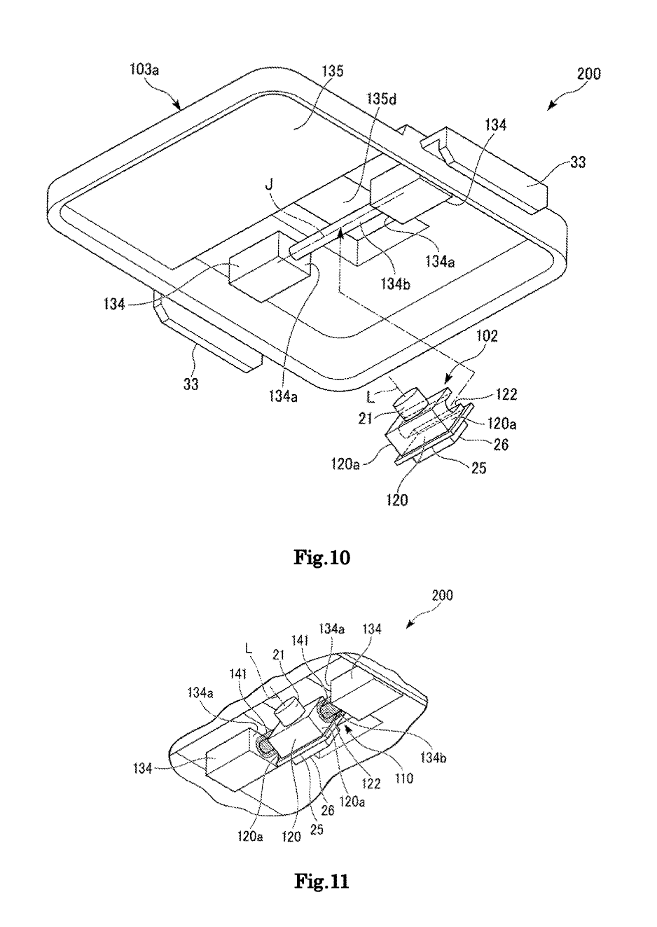

FIG. 10 is an exploded view of the vehicle-mounted camera 200. FIG. 11 is a partial perspective view of the vehicle-mounted camera 200. Note that, in FIG. 10, illustration of a processing board and a base housing is omitted.

The vehicle-mounted camera 200 is mainly different in the configuration of a bearing mechanism 110 compared with the vehicle-mounted camera 100 described above. Note that components same as the components in the preferred embodiment described above are denoted by the same reference numerals and signs and explanation of the components is omitted.

As shown in FIGS. 10 and 11, the vehicle-mounted camera 200 in this variation includes a cover housing 103a, a camera main assembly 102, and an adhesive (a fixing member) 141 that fixes the cover housing 103a and the camera main assembly 102 each other.

As shown in FIG. 10, the cover housing 103a includes a top plate 135 in which a camera housing portion 135d is provided. The top plate 135 includes a pair of housing-side seats 134 projecting downward from the lower surface. The pair of housing-side seats 134 is respectively disposed on the left and the right of the camera housing portion 135d. The pair of housing-side seats 134 respectively includes inner side surfaces 134a opposed to each other. A shaft portion 134b is bridged between the inner side surfaces 134a. The shaft portion 134b extends in the width direction on the lower side of the camera housing portion 135d. The shaft portion 134b has a columnar shape centering on the center axis (the rotation axis) J. The shaft portion 134b may be configured integrally with the cover housing 103a or may be configured to be combined as another member.

The camera main assembly 102 has one optical axis L. The camera main assembly 102 includes a base unit 120, the lens assembly 21, and the image sensor board 25. The base unit 120 is pierced through by the lens assembly 21. The image sensor board 25 is fixed to the rear surface of the base unit 120. As shown in FIG. 10, a bearing portion 122 having a recessed groove shape extending in the width direction is provided on the upper side of the base unit 120.

As shown in FIG. 11, the bearing portion 122 of the camera main assembly 102 configures the bearing mechanism 110 with the bottom surface of the bearing portion 122 set in contact with the shaft portion 134b. The bottom surface of the bearing portion 122 bends along the outer circumferential surface of the shaft portion 134b. Therefore, in the bearing mechanism 110, the shaft portion 134b is capable of rotating with respect to the bearing portion 122 about the center axis J. That is, the bearing mechanism 110 can rotate the camera main assembly 102 with respect to the cover housing 103a. Consequently, the bearing mechanism 110 can direct the direction of the optical axis L of the camera main assembly 102 to any direction.

The adhesive (the fixing member) 141 is in contact with both of the camera main assembly 102 and the cover housing 103a and fixes the bearing mechanism 110 to be incapable of rotating. The base unit 120 of the camera main assembly 102 includes a pair of outer side surfaces 120a on the width-direction outer side. The pair of outer side surfaces 120a is respectively opposed to the inner side surfaces 134a of the pair of housing-side seats 134. The adhesive 141 is located around the shaft portion 134b between the outer side surface 120a and the inner side surface 134a, respectively in contact with the outer side surface 120a and the inner side surface 134a, and hardened. The adhesive 141 is hardened in a state in which the camera main assembly 102 is rotated by the bearing mechanism 110 and the optical axis L is aligned in a desired direction. Consequently, the adhesive 141 can fix a relative position of the camera main assembly 102 relative to the cover housing 103a in a state in which the direction of the optical axis L of the camera main assembly 102 is directed to any direction.

According to this variation, as in the above-described preferred embodiments, it is possible to provide the vehicle-mounted camera and the method of manufacturing the vehicle-mounted camera that is low in costs and easy in angle adjustment of the optical axis L.

A vehicle-mounted camera 300 according to Variation 2 will be described.

FIG. 12 is a partial schematic view of the vehicle-mounted camera 300.

The vehicle-mounted camera 300 is mainly different in the configuration of a bearing mechanism 210 compared with the vehicle-mounted camera 100 described above. Note that components same as the components in the preferred embodiment described above are denoted by the same reference numerals and signs and explanation of the components is omitted.

As shown in FIG. 12, the vehicle-mounted camera 300 in this variation includes a cover housing 203a, the camera main assembly 2, and an adhesive (a fixing member) 241 that fixes the cover housing 203a and the camera main assembly 2 each other.

The cover housing 203a includes a top plate 235. A housing-side seat 234 projecting downward is provided on the lower surface of the top plate 235. A bearing portion 234b is provided on a lower surface 234a of the housing-side seat 234. In this variation, the bearing portion 234b is a recessed groove having a V-shape in section. The shaft portion 22 of the camera main assembly 2 is accommodated in the bearing portion 234b.

The shaft portion 22 of the camera main assembly 2 is accommodated in the bearing portion 234b of the cover housing 203a and configures the bearing mechanism 210. The bearing mechanism 210 can rotate the camera main assembly 2 with respect to the cover housing 203a. Consequently, the bearing mechanism 210 can direct the direction of the optical axis L of the camera main assembly 2 to any direction. The bearing mechanism 210 is fixed to be incapable of rotating by the adhesive (the fixing member) 241. The adhesive 241 is hardened in a state in which the camera main assembly 2 is rotated by the bearing mechanism 210 and the optical axis L is aligned in a desired direction. Consequently, the adhesive 241 can fix a relative position of the camera main assembly 2 relative to the cover housing 203a in a state in which the direction of the optical axis L of the camera main assembly 2 is directed to any direction.

According to this variation, as in the above-described preferred embodiment, it is possible to provide the vehicle-mounted camera that is low in costs and easy in angle adjustment of the optical axis L.

A vehicle-mounted camera 400 according to Variation 3 will be described.

FIG. 13 is a partial schematic view of the vehicle-mounted camera 400.

The vehicle-mounted camera 400 is mainly different in the configuration of a bearing mechanism 310 compared with the vehicle-mounted camera 100 described above. Note that components same as the components in the preferred embodiment described above are denoted by the same reference numerals and signs and explanation of the components is omitted.

As shown in FIG. 13, the vehicle-mounted camera 400 in this variation includes a cover housing 303a, the camera main assembly 2, and a fixing member 341 that fixes the cover housing 303a and the camera main assembly 2 each other.

The cover housing 303a includes a top plate 335. A housing-side seat 334 projecting downward is provided on the lower surface of the top plate 335. A pair of screw holes 334c and a bearing portion 334b having a recessed groove shape are provided on a lower surface 334a of the housing-side seat 334. The bearing portion 334b is located between the pair of screw holes 334c. Screws 342 for fixing the fixing member 341 are screwed in the screw holes 334c. The shaft portion 22 of the camera main assembly 2 is accommodated in the bearing portion 334b to configure a bearing mechanism 310. Further, the fixing member 341 opposed to the lower surface 334a of the housing-side seat 334 is attached to cover the shaft portion 22 of the camera main assembly 2.

The fixing member 341 includes a recessed groove 341a extending along the outer circumference of the shaft portion 22. The fixing member 341 is screwed to the housing-side seat 334 across the shaft portion 22 by the screws 342. The fixing member 341 holds the shaft portion 22 between the fixing member 341 and the housing-side seat 334 and suppresses the movement and the rotation of the shaft portion 22 while retaining the shaft portion 22 with the recessed groove 341a.

The bearing mechanism 310 is fixed to be incapable of rotating by the fixing member 341. The fixing member 341 rotates the shaft portion 22 to align the optical axis L of the camera main assembly 2 in a desired direction in a state in which the screws 342 are temporarily tightened and the bearing mechanism 310 is loosely fixed. The fixing member 341 firmly fixes the bearing mechanism 310 when the screws 342 are finally tightened.

According to this variation, as in the above-described preferred embodiments, it is possible to provide the vehicle-mounted camera and the method of manufacturing the vehicle-mounted camera that is low in costs and easy in angle adjustment of the optical axis L.

A vehicle-mounted camera 500 according to Variation 4 will be described.

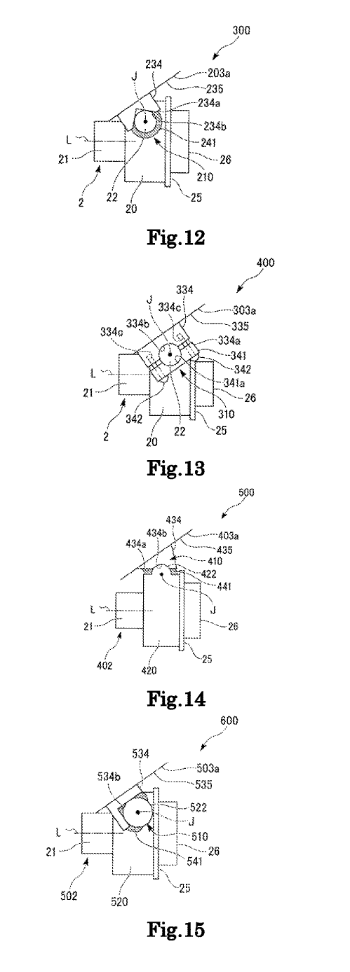

FIG. 14 is a partial schematic view of the vehicle-mounted camera 500.

The vehicle-mounted camera 500 is mainly different in the configuration of a bearing mechanism 410 compared with the vehicle-mounted camera 100 described above. Note that components same as the components in the preferred embodiment described above are denoted by the same reference numerals and signs and explanation of the components is omitted.

As shown in FIG. 14, the vehicle-mounted camera 500 in this variation includes a cover housing 403a, a camera main assembly 402, and an adhesive (a fixing member) 441 that fixes the cover housing 403a and the camera main assembly 402 each other.

The camera main assembly 402 has one optical axis L. The camera main assembly 402 includes a base unit 420, the lens assembly 21, and the image sensor board 25. A projection (a shaft portion) 422 projecting to the upper side is provided on the upper surface of the base unit 420. The projection 422 has a semicircular sectional shape in FIG. 14 and uniformly extends in the width direction.

The cover housing 403a includes a top plate 435. A housing-side seat 434 projecting downward is provided on the lower surface of the top plate 435. The bearing portion 434b is provided on a lower surface 434a of the housing-side seat 434. In this variation, the bearing portion 434b is a recessed groove extending in the width direction.

The projection 422 of the camera main assembly 402 is accommodated in the bearing portion 434b of the cover housing 403a to configure the bearing mechanism 410. The bearing mechanism 410 can rotate the camera main assembly 402 with respect to the cover housing 403a. Consequently, the bearing mechanism 410 can direct the direction of the optical axis L of the camera main assembly 402 to any direction. The bearing mechanism 410 is fixed to be incapable of rotating by the adhesive (the fixing member) 441. The adhesive 441 is hardened in a state in which the camera main assembly 402 is rotated by the bearing mechanism 410 and the optical axis L is aligned in a desired direction. Consequently, the adhesive 441 can fix a relative position of the camera main assembly 402 relative to the cover housing 403a in a state in which the direction of the optical axis L of the camera main assembly 402 is directed to any direction.

According to this variation, as in the above-described preferred embodiments, it is possible to provide the vehicle-mounted camera and the method of manufacturing the vehicle-mounted camera that is low in costs and easy in angle adjustment of the optical axis L.

A vehicle-mounted camera 600 according to Variation 5 will be described.

FIG. 15 is a partial schematic view of the vehicle-mounted camera 600.

The vehicle-mounted camera 600 is mainly different in the configuration of a bearing mechanism 510 compared with the vehicle-mounted camera 100. Note that components same as the components in the preferred embodiment are denoted by the same reference numerals and signs and explanation of the components is omitted.

As shown in FIG. 15, the vehicle-mounted camera 600 in this variation includes a cover housing 503a, a camera main assembly 502, and an adhesive (a fixing member) 541 that fixes the cover housing 503a and the camera main assembly 502 to each other.

The camera main assembly 502 has one optical axis L. The camera main assembly 502 includes a base unit 520, the lens assembly 21, and the image sensor board 25. A pair of shaft portions 522 extending to the width-direction outer side is provided on the width-direction both sides of the base unit 520. In this variation, the shaft portion 522 has a polygonal prism shape centering on the center axis (the rotation axis) J. In an illustrated example, the shaft portion 522 is a dodecagonal pillar.

The cover housing 503a includes a top plate 535. A housing-side seat 534 projecting downward is provided on the lower surface of the top plate 535. The housing-side seat 534 has a sectional shape of an L-shape in FIG. 15 and uniformly extends in the width direction. The housing-side seat 534 configures a bearing portion 534b.

The shaft portion 522 of the camera main assembly 502 is accommodated in the bearing portion 534b of the cover housing 503a to configure the bearing mechanism 510. The bearing mechanism 510 can rotate the camera main assembly 502 with respect to the cover housing 503a. Consequently, the bearing mechanism 510 can direct the direction of the optical axis L of the camera main assembly 502 to any direction. The bearing mechanism 510 is fixed to be incapable of rotating by the adhesive (the fixing member) 541. The adhesive 541 is hardened in a state in which the camera main assembly 502 is rotated by the bearing mechanism 510 and the optical axis L is aligned in a desired direction. Consequently, the adhesive 541 can fix a relative position of the camera main assembly 502 relative to the cover housing 503a in a state in which the direction of the optical axis L of the camera main assembly 502 is directed to any direction.

According to this variation, as in the above-described preferred embodiments, it is possible to provide the vehicle-mounted camera and the method of manufacturing the vehicle-mounted camera that is low in costs and easy in angle adjustment of the optical axis L.

The preferred embodiments and the variations of the present invention are described above. However, the components, the combinations of the components, and the like in the preferred embodiments and the variations are examples. Addition, omission, replacement, and other changes of components are possible within a range not departing from the spirit of the present invention. The present invention is not limited by the preferred embodiments and variations described herein.

For example, as described in the preferred embodiments and the variations, the bearing mechanisms are not limited to the preferred embodiments and the variations as long as the bearing mechanisms are capable of rotating about one rotation axis (center axis) J each other. Various forms of the bearing mechanisms are possible.

In the preferred embodiments and the variations, as the fixing member, the adhesive is used or the member to be screwed is used. However, the fixing member is not limited to the preferred embodiments and the variations as long as the fixing member fixes a relative positional relation between the camera main assembly and the cover housing.

In the preferred embodiments and the variations, the cover housing and the base housing are made of aluminum or an aluminum alloy. However, the cover housing and the base housing may be other metal materials or resin materials.

In addition to the camera main assembly, other vehicle-mounted devices such as a rain sensor, a millimeter wave radar sensor, and a laser radar sensor may be mounted on the vehicle-mounted cameras in the above-described preferred embodiments and the variations described above.

A configuration can also be adopted in which the lens assembly of the camera main assembly reaches the outer side from the viewing window of the cover housing.

The shapes, the positions, the directions, and the numbers of the housing-side seats and the camera-side seats are not limited to the preferred embodiments and the variations described above. Further, the housing-side seat may be provided in the base housing.

In the preferred embodiments and the variations, the shape of the top plate is simply described as the tabular shape. However, the shape of the top plate is not limited to the simple tabular shape. For example, the shape of the top plate may be a curved tabular shape or may be a shape having a step on the surface or thickness of which partially changes. If members have transverse dimensions exceeding ten times of the thicknesses of the members, all of the members are referred to as tabular in the present invention irrespective of what kinds of shapes details of the members have.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vehicle-mounted camera attached to a glass surface of a window glass inside a vehicle in a posture in which the vehicle-mounted camera extends along the window glass facing forward or rearward of a vehicle body, and capable of capturing an image of a scene of a vehicle exterior, the vehicle-mounted camera comprising:
a cover housing; and
a camera main assembly fixed to the cover housing and including a lens assembly and an image sensor;
a bearing mechanism interposed between the camera main assembly and the cover housing; wherein
a rotation axis of the bearing mechanism extends in a left-right direction defined relative to a front-back direction in which an optical axis of the lens assembly extends;
the vehicle-mounted camera includes a fixing member that fixes the bearing mechanism such that the bearing mechanism does not rotate; and
the fixing member is capable of contacting both of the camera main assembly and the cover housing or the bearing mechanism.

2. The vehicle-mounted camera according to claim 1, wherein the rotation axis is located between a distal end of the lens assembly and the image sensor in the front-back direction.

3. The vehicle-mounted camera according to claim 1, wherein the bearing mechanism includes a shaft portion of the camera main assembly and a bearing portion of the cover housing.

4. The vehicle-mounted camera according to claim 2, wherein the bearing mechanism includes a shaft portion of the camera main assembly and a bearing portion of the cover housing.

5. The vehicle-mounted camera according to claim 1, wherein the bearing mechanism includes a left bearing mechanism and a right bearing mechanism extending in directions away from the optical axis and located right and left of the optical axis.

6. The vehicle-mounted camera according to claim 2, wherein the bearing mechanism includes a left bearing mechanism and a right bearing mechanism extending in directions away from the optical axis and located right and left of the optical axis.

7. The vehicle-mounted camera according to claim 3, wherein the bearing mechanism includes a left bearing mechanism and a right bearing mechanism extending in directions away from the optical axis and located right and left of the optical axis.

8. The vehicle-mounted camera according to claim 4, wherein the bearing mechanism includes a left bearing mechanism and a right bearing mechanism extending in directions away from the optical axis and located right and left of the optical axis.

9. A manufacturing method for the vehicle-mounted camera according to claim 1, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

10. A manufacturing method for the vehicle-mounted camera according to claim 2, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

11. A manufacturing method for the vehicle-mounted camera according to claim 3, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

12. A manufacturing method for the vehicle-mounted camera according to claim 4, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

13. A manufacturing method for the vehicle-mounted camera according to claim 5, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

14. A manufacturing method for the vehicle-mounted camera according to claim 6, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

15. A manufacturing method for the vehicle-mounted camera according to claim 7, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.

16. A manufacturing method for the vehicle-mounted camera according to claim 8, the manufacturing method comprising:
preparing the cover housing, the camera main assembly, and the fixing member;
specifying an attachment angle of the camera main assembly to the cover housing;
attaching the camera main assembly to the cover housing;
adjusting the attachment angle of the camera main assembly to the specified angle using the bearing mechanism; and
fixing, with the fixing member, the bearing mechanism such that the bearing mechanism does not rotate.
